(19) United States
(12) Patent Application Publication
(10) Pub. No.: US 2014/0086021 A1
(43) Pub. Date: Mar. 27, 2014

(54) Electronic Timepiece And Method Of Controlling An Electronic Timepiece

(71) Applicant: Seiko Epson Corporation, Tokyo (JP)

(72) Inventor: Norimitsu Baba, Nagano-ken (JP)

(73) Assignee: Seiko Epson Corporation, Tokyo (JP)

(21) Appl. No.: 14/022,618

(22) Filed: Sep. 10, 2013

(30) Foreign Application Priority Data
Sep. 25, 2012 (JP) 2012-210460

(51) Int. Cl. G04R 20/04

(52) U.S. Cl. CPC G04R 20/04
USPC 368/47

(57) ABSTRACT

An electronic timepiece has a GPS receiver, outdoor detection device, timekeeping device, control device, and storage device. The control device has an automatic reception control unit that starts reception control when the time kept by the timekeeping device reaches the reception control start time stored in the storage device, and stops reception control until the next reception control start time when a stop reception control condition is met; and a time correction unit that corrects the time kept by the timekeeping device based on time information contained in the satellite signal when satellite signal reception is successful. The automatic reception control unit includes an outdoor reception control unit that executes an outdoor reception process when the outdoor detection device detects being outdoors, and a scheduled reception control unit that executes a scheduled reception process when the time kept by the timekeeping device goes to the scheduled reception time.

### BACKGROUND

1. Technical Field

The present invention relates to an electronic timepiece that adjusts the time by receiving satellite signals transmitted from GPS or other positioning information satellites, and to a method of controlling an electronic timepiece.

2. Related Art

Electronic timepieces that receive satellite signals from GPS (Global Positioning System) satellites and perform positioning and time adjustment operations are known from the literature. See, for example, Japanese Unexamined Patent Appl. Pub. JP-A-2008-39565.

When the electronic timepiece is a timepiece such as a wristwatch that moves with the user, the electronic timepiece may move to an environment where satellite signals cannot be received, such as indoors or an underground mall.

If the reception process is executed in such an environment where satellite signals cannot be received, power is wasted. Reducing current consumption and avoiding wasteful reception processes are particularly important in battery-powered electronic timepieces such as wristwatches to assure sufficient duration time and reduce the battery size.

JP-A-2008-39565 therefore describes providing a solar panel in the electronic timepiece, determining if the electronic timepiece is outdoors by comparing the power output of the solar panel with a threshold value for determining if the electronic device is indoors or outdoors, and performing the reception process if determined to be outdoors.

However, solar panel power output depends upon the illuminance of the light incident to the solar panel. It was therefore thought that an indoor/outdoor determination could be made by obtaining the power output corresponding to the illuminance when the electronic timepiece is outdoors during the day and the illuminance when indoors, and setting the threshold value to differentiate between these power output levels.

However, even if the electronic timepiece is outdoors, power output may not exceed the threshold value depending on the operating conditions of the electronic timepiece. For example, when the electronic timepiece is a wristwatch, power output may not exceed the threshold value even though the electronic timepiece is outdoors if the solar cell is covered by a sleeve, for example. Depending upon the season or the weather, power output may also not exceed the threshold value even though the electronic timepiece is outdoors because direct sunlight is not incident or is weak.

As a result, the automatic reception process may not execute for several days during the winter or other times when long-sleeved jackets or clothing are worn, the number of times the automatic reception process executes therefore drops, and the probability of successful reception drops.

### SUMMARY

An electronic timepiece and a method of controlling an electronic timepiece according to the present invention can appropriately adjust the content of the automatic reception process and improve the probability of successful reception.

An electronic timepiece according to one aspect of the invention has a receiver device that receives a satellite signal transmitted from a positioning information satellite; an outdoor detection device that detects being outdoors; a timekeeping device that keeps time; a storage device that stores at least a reception control start time and a scheduled reception time; and a control device that controls the receiver device. The control device includes a reception control unit that starts reception control when the time kept by the timekeeping device reaches the reception control start time stored in the storage device, and when a preset stop reception control condition is met, stops reception control until the next reception control start time, and a time correction unit that acquires time information contained in the satellite signal and corrects the time kept by the timekeeping device based on the acquired time information when satellite signal reception is successful. The reception control unit includes an outdoor reception control unit that operates the receiver device and executes an outdoor reception process when the outdoor detection device detects being outdoors; and a scheduled reception control unit that operates the receiver device and executes a scheduled reception process when the time kept by the timekeeping device goes to the scheduled reception time.

This aspect of the invention has two types of control units as reception control units, an outdoor reception control unit and a scheduled reception control unit. The number of opportunities for executing an reception process meeting conditions for automatic reception can therefore be increased, and the probability of successful reception can be increased. The probability of successfully receiving a satellite signal and acquiring time information can therefore be improved, and the time displayed by the electronic timepiece can be adjusted to the correct time.

More specifically, because the electronic timepiece has an outdoor reception control unit, the reception process can be started automatically if the user wearing the electronic timepiece moves outdoors and the electronic timepiece being outdoors can be detected. If the outdoor reception process is executed, the probability of successfully receiving a satellite signal transmitted from a positioning information satellite can be increased compared with executing the reception process indoors, and consuming power wastefully due to failed reception can be prevented.

Furthermore, because the electronic timepiece also has a scheduled reception control unit, the reception process can be executed at a scheduled time when reception by the outdoor reception control unit alone is not possible for a long time. For example, the electronic timepiece may be outdoors, but cannot be determined to be outdoors because the electronic timepiece is covered by the user's sleeve. In this situation, the outdoor reception control unit cannot start the reception process.

By having a scheduled reception control unit, however, the satellite signal can be received at a preset scheduled reception time. The reception process can therefore be reliably executed irrespective of the result of determining if the electronic timepiece is outdoors.

By thus using two reception control units, the appropriate reception process can be executed to improve the probability of successful reception, opportunities for automatically correcting the time displayed by the electronic timepiece based on time information acquired from the satellite signal can therefore be increased, the correct time can always be displayed, and convenience can be improved.

The reception control unit also starts reception control when the reception control start time stored in the storage device is reached, and when the condition for stopping reception control is met, stops reception control until the next start time. The timing when the outdoor reception process and the scheduled reception process execute can therefore be set by setting the reception control start time and the scheduled reception time. The reception process can therefore be executed at a time appropriate to the user, and the probability of successful reception can be improved accordingly.

The reception control unit can also be stopped until the next start time when the condition for stopping reception control is met. As a result, the outdoor detection device can also be stopped, for example, and power consumption can be reduced compared with continuing to operate the reception control unit.

In an electronic timepiece according to another aspect of the invention, the reception control unit ends reception control without executing the other reception process if satellite signal reception is successful in either the outdoor reception process or the scheduled reception process during the time from the start time stored in the storage device until the next start time, but executes the other reception process if satellite signal reception fails in either the outdoor reception process or the scheduled reception process during this time.

When satellite signal reception is successful in either the outdoor reception process controlled by the outdoor reception control unit or the scheduled reception process controlled by the scheduled reception control unit, the other reception process is not executed. As a result, if reception is successful in whichever of the outdoor reception process and scheduled reception process executes first, control can stop without executing the other reception process. More specifically, both processes are executed only if the first reception process fails to receive a satellite signal. The average number of reception processes executed until time information is acquired can therefore be reduced, and power consumption can be suppressed.

When receiving a satellite signal fails in one reception process and receiving a satellite signal also fails in the other reception process, reception control can be stopped or reception control can continue.

Reception control also normally stops immediately if one reception process fails to receive a satellite signal and the other reception process succeeds in receiving a satellite signal.

In an electronic timepiece according to another aspect of the invention, the stop reception control condition is that the reception control unit executed the outdoor reception process once, and executed the scheduled reception process once, during the time from the start time stored in the storage device until the next start time.

This aspect of the invention stops reception control if the outdoor reception control unit executes the outdoor reception process once and the scheduled reception control unit executes the scheduled reception process once during a preset period of time, and each reception process therefore does not repeat. The outdoor reception process can therefore be prevented from executing repeatedly if the person wearing the electronic timepiece moves repeatedly between indoors and outdoors. This prevents the electronic timepiece from stopping as a result of the reception process executing repeatedly and consuming too much power.

In an electronic timepiece according to another aspect of the invention, the stop reception control condition is that the reception control unit executed the outdoor reception process a preset number of times, and executed the scheduled reception process number of times, during the time from the start time stored in the storage device until the next start time.

The number of times the outdoor reception process executes, and the number of times the scheduled reception process executes, can be the same or different. These numbers can also be once, or two or more plural times. These numbers can also be set in the electronic timepiece at the factory, or set manually by the user. The voltage of the power supply (such as a storage battery) of the electronic timepiece may also be detected, and the number of times the reception processes execute changed, according to the voltage.

As a result, the outdoor reception process could be set to execute twice, and the scheduled reception process to execute once, for example.

Because the number of times the outdoor reception process and the scheduled reception process execute within a predetermined period of time can be set individually, the reception operation can be configured more finely. For example, wristwatches are generally available in a large size for men and a small size for women. The size of the battery that can be used in a large wristwatch is relatively large, and battery capacity can be increased accordingly. The size of the battery that can be used in a small wristwatch is accordingly smaller, and battery capacity is lower.

Therefore, when battery capacity is high and the reception process can be executed four times a day, for example, the number of times the reception process executes increases and the probability of successful reception can be improved. In this configuration the outdoor reception process may be set to run 3 times and the scheduled reception process to run once, or the outdoor reception process could be set to run 2 times and the scheduled reception process to run 2 times, for example.

When the battery is small, the battery capacity is low, and the reception process can only run 3 times a day, the outdoor reception process may be set to run a maximum 2 times and the scheduled reception process to run once, for example.

Because the number of times the reception process runs can be set with consideration for the battery capacity of the electronic timepiece, for example, this aspect of the invention can appropriately set the number of times the reception process runs and improve the probability of successful reception.

An electronic timepiece according to another aspect of the invention preferably also has an operating unit to manually input a time; and the control device stores the time input by the operating unit as the scheduled reception time in the storage device.

Because this aspect of the invention enables the user to manually set the scheduled reception time, the scheduled reception time can be set according to the daily schedule of the user when reception is easy and the user is likely outdoors, such as while commuting. The probability of successful reception in the scheduled reception process can therefore be improved.

An electronic timepiece according to another aspect of the invention preferably also has an operating unit to manually operate the receiver device. The control device has a manual reception control unit that operates the receiver device and executes a manual reception process when the reception operation of the operating unit is detected, and stores the time reception succeeded as the scheduled reception time when satellite signal reception is successful in the manual reception process.

When the manual reception process is run in this aspect of the invention, there is a strong possibility that the user manually started reception while outdoors in a place suited to satellite signal reception. Because the daily schedule of the user is generally the same, if the user starts reception manually while commuting to work and reception succeeds one day, there is a strong possibility that user will also be outdoors at the same time on another day. The probability of successful reception in the scheduled reception process can therefore be improved by setting the time that reception succeeded in a manual reception process as the scheduled reception time.

In an electronic timepiece according to another aspect of the invention, the control device stores the time reception succeeded as the scheduled reception time in the storage device when satellite signal reception is successful in the outdoor reception process.

When satellite signal reception succeeds in the outdoor reception process, there is a strong possibility that reception process was executed because the user being outdoors in a location suitable to satellite signal reception was appropriately detected. Because the daily schedule of the user is generally the same, there is a strong possibility that user will also be outdoors on another day at the same time that the outdoor reception process was successful. The probability of successful reception in the scheduled reception process can therefore be improved if the scheduled reception time is set to the time that reception succeeded in the outdoor reception process.

In an electronic timepiece according to another aspect of the invention, the control device executes the scheduled reception process after executing the outdoor reception process during the time from the start time stored in the storage device until the next start time.

In this aspect of the invention the scheduled reception process does not execute if the outdoor reception process has not executed. As a result, because neither the outdoor or scheduled reception process is executed when the electronic timepiece is in a place, such as in a drawer, where the outdoor detection device cannot determine the electronic timepiece is outdoors, the likelihood of the reception process running where satellite signals cannot be received can be reduced, and power consumption can be reduced accordingly.

In an electronic timepiece according to another aspect of the invention, the control device executes the outdoor reception process after executing the scheduled reception process during the time from the start time stored in the storage device until the next start time.

Because the outdoor reception process does not run until the scheduled reception process has run, the user can set the scheduled reception time to a time when the outdoor reception process can be executed. The timing of the outdoor reception process can therefore be set according to the user's daily schedule, and the probability of successful satellite signal reception in the outdoor reception process can be improved. As a result, the reception process can be executed effectively, and wasteful power consumption can be suppressed.

An electronic timepiece according to another aspect of the invention preferably also has a solar cell; the outdoor detection device is an illuminance detection device that detects the illuminance of light incident to the solar cell; and the control device determines the electronic timepiece is outdoors if the illuminance detected by the illuminance detection device equals or exceeds a preset threshold, and determines the electronic timepiece is not outdoors if less than the threshold.

Because an illuminance detection device that detects the illuminance of light on the solar cell is used as the outdoor detection device in this aspect of the invention, being outdoors can be detected accurately. More specifically, the possibility that the electronic timepiece is not hidden from satellite signals by a building, for example, and is located where satellite signals can be desirably received increases as the illuminance of light on the solar cell increases. That the electronic timepiece is outdoors can therefore be accurately detected with this aspect of the invention.

In addition, because the solar cell provided for charging the storage battery used as the power supply of the electronic timepiece can also be used for outdoor detection, cost can be reduced compared with a configuration using a UV sensor or other dedicated part for detecting if the electronic timepiece is outdoors.

An electronic timepiece according to another aspect of the invention preferably also has an operating unit to manually input a time; and the control device stores the time input by the operating unit as the reception control start time in the storage device.

Because this aspect of the invention enables the user to set the reception control start time, the reception control start time can be set with consideration for the user's daily schedule, the reception process can be executed efficiently, and power consumption can be reduced.

For example, if the reception control start time is set to a time when the user is typically outdoors, the outdoor receptionprocess can execute immediately after reception control starts. The outdoor detection device therefore does not need to operate for a long time, and power consumption can be reduced accordingly.

Another aspect of the invention is a control method of an electronic timepiece including a receiver device that receives a satellite signal transmitted from a positioning information satellite, an outdoor detection device that detects being outdoors, a timekeeping device that keeps time, and a storage device that stores at least a reception control start time and a scheduled reception time. The control method includes steps of: starting reception control when the time kept by the timekeeping device reaches the reception control start time stored in the storage device, and stopping reception control until the next reception control start time when a preset stop reception control condition is met; and acquiring time information contained in the satellite signal and correcting the time kept by the timekeeping device based on the acquired time information when satellite signal reception is successful. Reception control includes executing an outdoor reception process that operates the receiver device when the outdoor detection device detects being outdoors; and a scheduled reception process that operates the receiver device when the time kept by the timekeeping device goes to the scheduled reception time.

The control method of an electronic timepiece according to the invention achieves the same effect as the electronic timepiece described above. More specifically, because the method of controlling an electronic timepiece according to this aspect of the invention executes two reception processes, there are more opportunities to run the reception process, and the probability of successful reception can be improved. There are also more opportunities to automatically correct the time displayed by the electronic timepiece based on the time information acquired from the satellite signal, the correct time can always be displayed, and user convenience can be improved.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a plan view showing an electronic timepiece according to a first embodiment of the invention.

FIG. 2 is a section view of the electronic timepiece.

FIG. 3 is a block diagram showing the configuration of the electronic timepiece.

FIG. 4 is a flow chart of the satellite signal reception process of the control device in the first embodiment.

FIG. 5 is a timing chart of operation for charge state detection and open-circuit voltage detection.

FIG. 6 is a graph showing the relationship between the illuminance of light incident to the solar cell of the electronic timepiece and the open-circuit voltage of the solar cell.

FIG. 7 shows the relationship between the open-circuit voltage of the solar cell and the illuminance of light incident to the solar cell at various illuminance detection levels.

FIG. 8 is a flow chart of the satellite signal reception process of the control device in a second embodiment of the invention.

FIG. 9 is a flow chart of the satellite signal reception process of the control device in a third embodiment of the invention.

FIG. 10 is a flow chart of the satellite signal reception process of the control device in a fourth embodiment of the invention.

FIG. 11 is a flow chart of the satellite signal reception process of the control device in a fifth embodiment of the invention.

FIG. 12 is a flow chart of the satellite signal reception process of the control device in a sixth embodiment of the invention.

### DESCRIPTION OF EMBODIMENTS

A preferred embodiment of the present invention is described below with reference to the accompanying figures.

### Embodiment 1

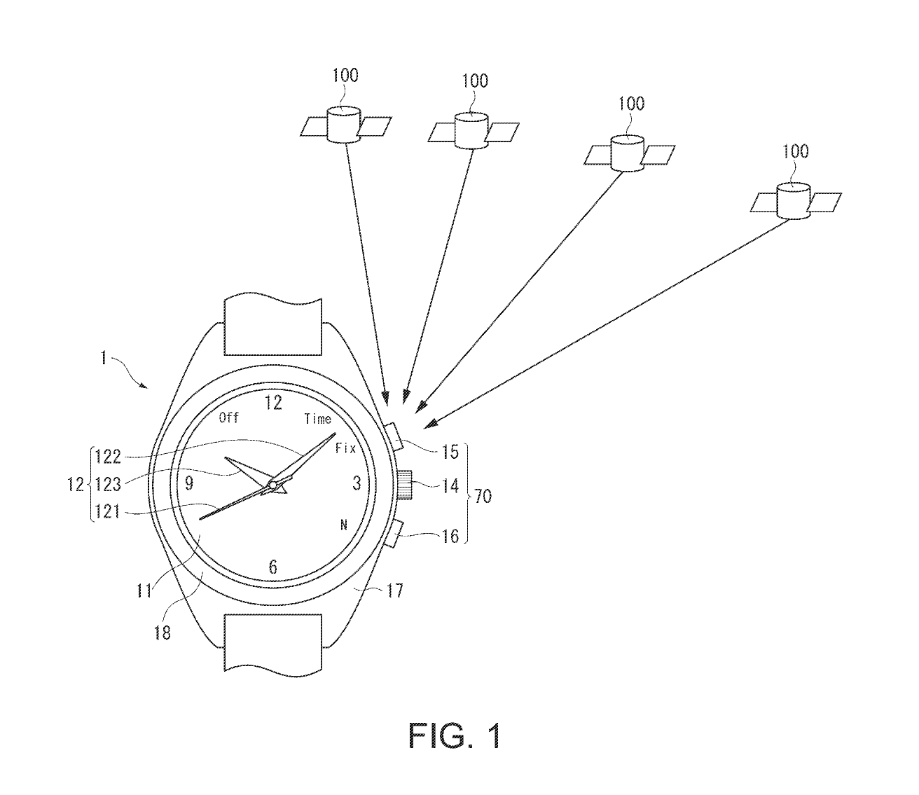

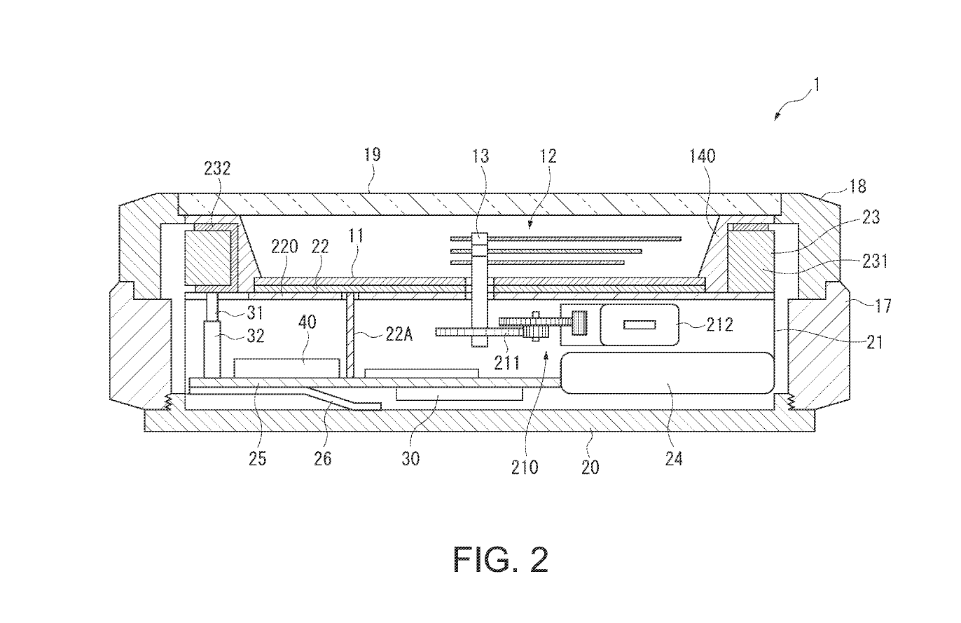

FIG. 1 is a plan view of a wristwatch with GPS receiver as an example of an electronic timepiece 1 according to the first embodiment of the invention. FIG. 2 is a section view of the electronic timepiece 1.

As shown in FIG. 1, the electronic timepiece 1 receives satellite signals from a plurality of GPS satellites 100 (positioning information satellites) orbiting the Earth on specific known orbits, acquires satellite time information by receiving a satellite signal from at least one GPS satellite 100, and acquires positioning information by receiving satellite signals from at least three GPS satellites 100.

The GPS satellite 100 is used as an example of a positioning information satellite in the invention, and there are multiple positioning information satellites in a constellation. There are currently approximately 30 GPS satellites 100 in the GPS constellation.

Electronic Timepiece

As shown in FIG. 1, the electronic timepiece 1 in this embodiment of the invention is a wristwatch that is worn on the user's wrist, has a dial 11 and hands 12, and keeps and displays the time.

The greater part of the dial 11 is made from a non-metallic material, such as plastic or glass, that is transparent to light and microwaves in the 1.5 GHz band.

The hands 12 are disposed on the exposed face side of the dial 11. The hands 12 include a second hand 121, minute hand 122, and hour hand 123 that rotate on a center pivot 13, and are driven by a stepper motor through a wheel train.

Operation of External Operating Members

The electronic timepiece 1 executes specific processes according to manual operation of external operating members 70 (operating units) including a crown 14 and pushers 15, 16.

For example, if the one pusher 15 is pressed for a long time (such as 3 seconds or more), a manual reception process (unconditional reception process) for receiving satellite signals is executed. If the other pusher 16 is pressed, a selection process that changes the reception mode (timekeeping mode or positioning mode) is executed. The reception mode selected by operating the pusher 16 is stored in a memory device 60 described below.

If the positioning mode is selected, the second hand 121 jumps to the FIX position (at 2:00). If the timekeeping mode is selected, the second hand 121 jumps to the TIME position (at 1:00). The user can therefore easily know which mode is set.

During reception control as described below, the reception mode may be fixed to the timekeeping mode irrespective of the mode set by the pusher 16, or the reception mode set with the pusher 16 could be used during reception control. As described below, operation is fixed to the timekeeping mode during reception control in this embodiment.

If pusher 15 is pressed for a short time (such as less than 3 seconds), a result display process that displays the result of the last reception process is executed. More specifically, if reception is successful in the positioning mode, the second hand 121 goes to the FIX (2:00) position. If reception is successful in the timekeeping mode, the second hand 121 goes to the TIME (1:00) position. If reception fails, the second hand 121 goes to the N position (at 4:00).

These indications are also made by the second hand 121 during reception. During reception in the positioning mode, the second hand 121 goes to the FIX (2:00) position. During reception in the timekeeping mode, the second hand 121 goes to the TIME (1:00) position. If a GPS satellite 100 cannot be locked onto, the second hand 121 goes to the N position (at 4:00).

Construction of an Electronic Timepiece

As shown in FIG. 2, the electronic timepiece 1 has a case 17 made of stainless steel (SUS), titanium, or other metal. The case 17 is substantially cylindrical.

A crystal 19 is attached to the opening on the face side of the case 17 with a bezel 18. The bezel 18 is made of ceramic or other non-metallic material to improve satellite signal reception performance. A back cover 20 is attached to the opening on the back side of the case 17.

A movement 21, solar cell 22, GPS antenna 23, and storage battery 24 are disposed inside the case 17.

The movement 21 includes a drive mechanism 210 including a stepper motor and wheel train that drive the hands 12. The stepper motor includes a motor coil 212, stator, and rotor, and drives the hands 12 through the wheel train 211 and center pivot 13.

A circuit board 25 is disposed on the back cover 20 side of the movement 21.

Disposed to the circuit board 25 are a GPS receiver module 30 including a receiver circuit that processes satellite signals received through the GPS antenna 23, and a control device 40 that controls operation, including drive control of the stepper motor. The GPS receiver module 30 and control device 40 are driven by power supplied from a storage battery 24.

Solar Cell

The solar cell 22 is a photovoltaic device that produces power by converting light energy to electrical energy. The solar cell 22 has an electrode for outputting the generated power, and is disposed on the back cover side of the dial 11. Because the greater part of the dial 11 is made from a material through which light passes easily, the solar cell 22 can receive light through the crystal 19 and dial 11 and produce power.

The solar cell 22 is supported by a solar panel support substrate 220. The solar panel support substrate 220 is a conductive plate approximately 0.1 mm thick, and made of metal such as brass, stainless steel (SUS), or titanium alloy. As a result, the solar panel support substrate 220 has the same current distribution as the GPS antenna 23 disposed nearby, and functions as part of the GPS antenna 23, as further described below.

The solar panel support substrate 220 is installed so that it does not contact the case 17. More specifically, the solar panel support substrate 220 is disposed so that its outside edge is separated from and does not contact the inside surface of the case 17.

The solar cell 22 connects to the circuit board 25 through a conductive coil spring 22A, and current produced by the solar cell 22 is stored in the storage battery 24 through the conductive coil spring 22A.

The solar panel support substrate 220 cannot be seen from the outside because the outside diameters of the dial 11 and solar cell 22 are determined according to the inside diameter of the dial ring 140, and their outside edges are hidden by the dial ring 140. The outside dimension of the solar panel support substrate 220 also exceeds the size of the solar cell 22 and dial 11, and the solar panel support substrate 220 extends to below the GPS antenna 23.

GPS Antenna

The GPS antenna 23 is a ring antenna including a ring-shaped dielectric base 231 that is rectangular in section, and an antenna electrode 232 formed on the surface of the dielectric base 231.

The dielectric base 231 shortens the wavelength of the radio waves, and may be made of materials such as a ceramic of primarily alumina (Σr=8.5), a ceramic of primarily mica such as Mycalex (R) (Σr=6.5−9.5), glass (Σr=5.4−9.9), or diamond (Σr=5.68).

The antenna electrode 232 is formed as a line in unison with the dielectric base 231 by printing a copper, silver, or other conductive metal material on the surface of the dielectric base 231, or bonding a silver, copper, or other conductive metal plate to the surface of the dielectric base 231. The antenna electrode 232 may also be formed by an electroless plating pattern on the surface of the dielectric base 231.

A connector pin 31 contacts the antenna electrode 232. The connector pin 31 is inserted to a substantially tubular connector base 32. The connector base 32 rises vertically and is connected to a printed wiring line on the circuit board 25.

The connector pin 31 and connector base 32 are electrically connected through the printed line to the GPS receiver module 30. The connector base 32 has an urging member such as a coil spring inside the tube part, and urges the connector pin 31 inserted to the connector base 32 to the antenna electrode 232 side. The connector pin 31 is thereby pressed against the feed node of the antenna electrode 232, and the connection between the connector pin 31 and antenna electrode 232 is maintained even when the electronic timepiece 1 is subject to impact shock.

The conductive back cover 20 also functions as the ground plane (reflector) of the GPS antenna 23 in this embodiment of the invention. The back cover 20 is conductive to a ground terminal 26 disposed to the movement 21. The ground terminal 26 connects to the ground potential of the GPS receiver module 30 of the movement 21. The back cover 20 is therefore electrically connected to the ground potential of the GPS receiver module 30 through the ground terminal 26, and functions as a ground plane (reflector) that reflect radio waves incident from the crystal 19 side to the GPS antenna 23. Because the conductive case 17 in contact with the back cover 20 also goes to ground potential, the case 17 also functions as a ground plane.

In addition to functioning as a ground plane, the back cover 20 and case 17 are metal and therefore also prevent adverse effects on the GPS antenna 23 when the electronic timepiece 1 is worn on the user's wrist. More specifically, if the case is a plastic case, the resonance frequency of the GPS antenna 23 is affected by the user's arm and differs depending on whether or not the electronic timepiece 1 is being worn, and performance varies undesirably. However, because the case is metal in this embodiment, effects from the body can be avoided by the shield effect of the case, there is substantially no difference in antenna characteristics when the electronic timepiece 1 is being worn and not worn, and stable reception process can be achieved.

Storage Battery

The storage battery 24 is the power source of the electronic timepiece 1, and stores power generated by the solar cell 22.

Two electrodes of the solar cell 22 and two electrodes of the storage battery 24 can be electrically connected to each other by two conductive coil springs 22A, and when thus connected the storage battery 24 can be charged by the power generated by the solar cell 22 of the electronic timepiece 1.

A lithium ion battery that is suitable for mobile devices is used as the storage battery 24 in this embodiment of the invention, but a lithium polymer battery or other type of storage battery can be used. A storage device other than a storage battery (such as a capacitive device) can also be used.

GPS Receiver

The GPS receiver module 30 is a load that is driven by power stored in the storage battery 24, and receives satellite signals from the GPS satellites 100 through the GPS antenna 23 when driven by the control device 40. When satellite signal reception is successful, the GPS receiver module 30 sends the acquired orbit information, GPS time information, and other information to the control device 40. When satellite signal reception fails, the GPS receiver module 30 sends a failure report to the control device 40. Note that the configuration of the GPS receiver module 30 is the same as the configuration of a GPS receiver known from the literature, and description thereof is omitted.

Electronic Timepiece Circuits

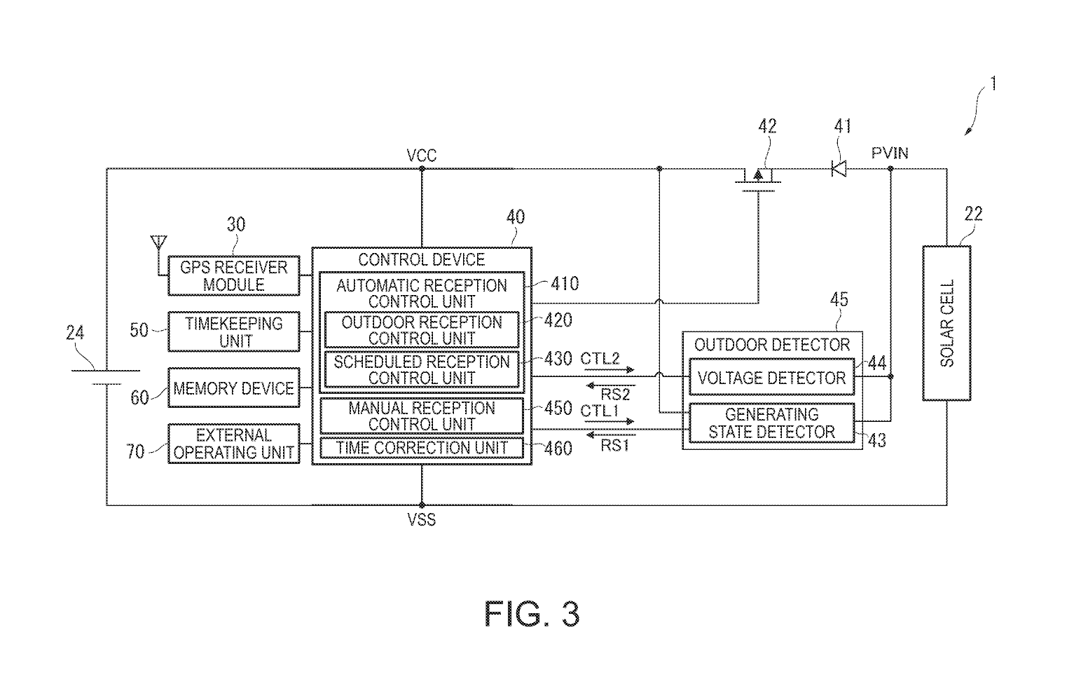

FIG. 3 is a block diagram showing the circuit design of the electronic timepiece 1. As shown in the figure, the electronic timepiece 1 has a solar cell 22, storage battery 24, GPS receiver module 30, control device 40, diode 41, charging control switch 42, generating state detector 43, voltage detector 44, timekeeping unit 50, memory device 60, and external operating unit 70.

The illuminance detector of the invention is embodied by the generating state detector 43 and voltage detector 44, and the outdoor detector 45 of the invention is embodied by the illuminance detector.

The control device 40 includes a CPU that controls the electronic timepiece 1. The control device 40 includes an automatic reception control unit 410 and a manual reception control unit 450 as reception control units that control the GPS receiver module 30 and execute reception processes. The control device 40 also has a time correction unit 460 that acquires time information contained in the satellite signals received by the GPS receiver module 30, and corrects (adjusts) the internal time kept by the timekeeping unit 50 based on the acquired time information.

Automatic Reception Control Unit

The automatic reception control unit 410 (reception control unit) runs a reception process that operates the GPS receiver module 30 automatically when a specific reception condition is met, and includes an outdoor reception control unit 420 and a scheduled reception control unit 430.

As described below, the outdoor reception control unit 420 operates the outdoor detector 45 and determines if the electronic timepiece 1 is outdoors, and if the electronic timepiece 1 is outdoors, operates the GPS receiver module 30 and runs the reception process.

The scheduled reception control unit 430 operates the GPS receiver module 30 and runs the reception process at the scheduled reception time stored in the memory device 60 as described below.

Manual Reception Control Unit

The manual reception control unit 450 operates the GPS receiver module 30 and runs the reception process (manual reception process, unconditional reception process) when the user intentionally presses a pusher 15 of the external operating unit 70 for several seconds (such as 3 seconds) or more.

The diode 41 is disposed in the path electrically connecting the solar cell 22 and storage battery 24, does not block current flow from the solar cell 22 to the storage battery 24 (forward current), and blocks current flow from the storage battery 24 to the solar cell 22 (reverse current). Current flows forward only when the voltage output of the solar cell 22 is higher than the voltage of the storage battery 24, that is, when charging. Note that a field-effect transistor (FET) could be used instead of the diode 41.

The charging control switch 42 closes and opens the path of current from the solar cell 22 to the storage battery 24, and is a switching device disposed in the path electrically connecting the solar cell 22 and storage battery 24. The charging control switch 42 turns on (closes) when the switching device goes from the off state to the on state, and turns off (opens) when the switching device goes from the on state to the off state.

For example, when the battery voltage of the storage battery 24 is greater than or equal to a threshold, the charging control switch 42 turns off so that battery characteristics do not deteriorate due to overcharging.

The switching device in this embodiment is a p-channel transistor, is on when the gate voltage is low, and is off when the gate voltage is high. The control device 40 therefore controls the gate voltage of the switching device to turn the charging control switch 42 on or off.

Generating State Detector

The generating state detector 43 operates according to a binary control signal CTL1 that specifies the generating state (charging state) detection time, detects the state of charging (charging state) from the solar cell 22 to the storage battery 24, and outputs detection result RS1 to the control device 40.

The charging state is either charging or not-charging, and is detected based on the battery voltage VCC and the terminal voltage PVIN of the solar cell 22 when the charging control switch 42 is on. For example, if the drop voltage of the diode 41 is Vth, the on resistance of the switching device is ignored, and PVIN−Vth>VCC, the charging state is “charging” (generating power); if PVIN−Vth<=VCC, the charging state is “not-charging” (not generating power).

The control signal CTL1 in this embodiment is a pulse signal with a 1 second period, and the generating state detector 43 detects the charging state while the control signal CTL1 is high. More specifically, the generating state detector 43 detects the charging state repeatedly at a 1-s period while the charging control switch 42 remains closed.

The charging state is detected intermittently to reduce power consumption by the generating state detector 43. If this reduction is unnecessary, the charging state may be detected continuously. The generating state detector 43 can be configured using a comparator or A/D converter, for example.

Voltage Detector

The voltage detector 44 operates based on a binary control signal CTL2 that specifies the voltage detection timing, and detects the terminal voltage PVIN of the solar cell 22, that is, the open-circuit voltage of the solar cell 22, when the charging control switch 42 is turned of f by the control signal CTL2. When the generating state detector 43 determines the solar cell 22 is generating, the control device 40 outputs the control signal CTL2 and operates the voltage detector 44. The voltage detector 44 also outputs the detection result RS2 of the open-circuit voltage to the control device 40.

Timekeeping Unit

The timekeeping unit 50 includes the movement 21, and executes a timekeeping process driven by power stored in the storage battery 24. This timekeeping process keeps the time, and indicates the kept time (display time) with the hands 12.

The memory device 60 stores information such as the reception mode (positioning mode, timekeeping mode), the start time for reception control (automatic reception control), and the scheduled reception time. The capacity of the memory device 60 is determined appropriately according to the number of data and the amount of information to be stored.

The reception mode can be selected by operating the pusher 16. The scheduled reception time may be a time set by the user, or the time of the last successful reception, for example.

The start time of reception control (such as 12:00) can be stored when the electronic timepiece 1 is manufactured at the factory. This reception control start time can be fixed so that it cannot be changed by the user, or made changeable by the user manually operating the external operating unit 70. By enabling the user to set a scheduled reception time, the reception time can be set according to the user's pattern of use even if the reception control start time is fixed to the factory setting.

Operation of the Control Device

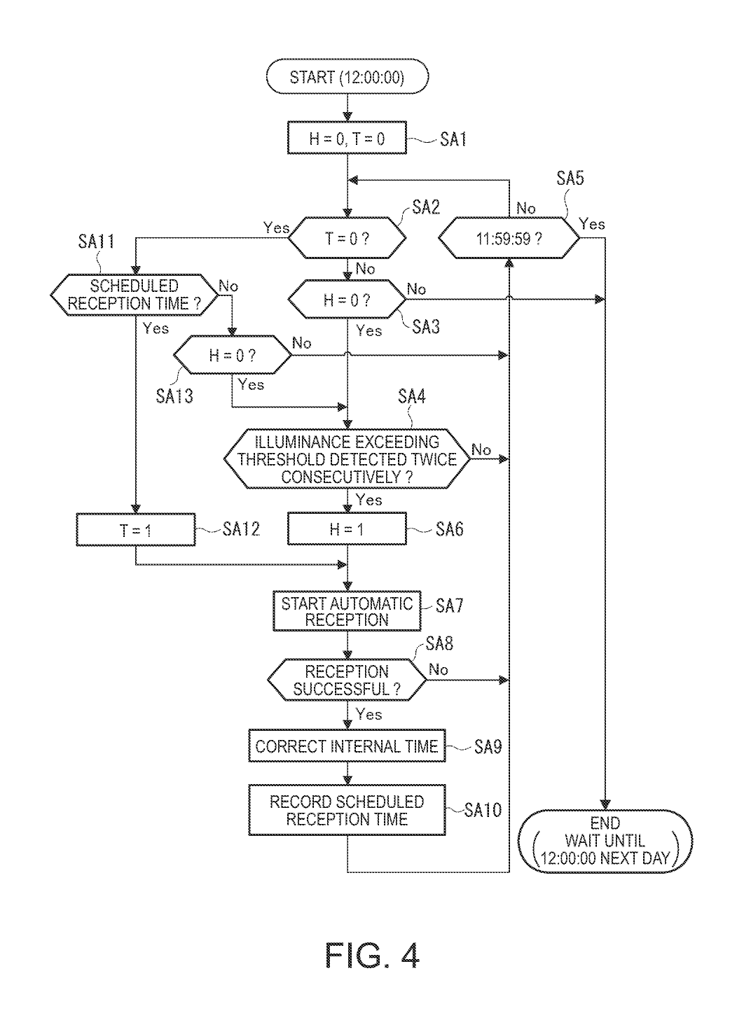

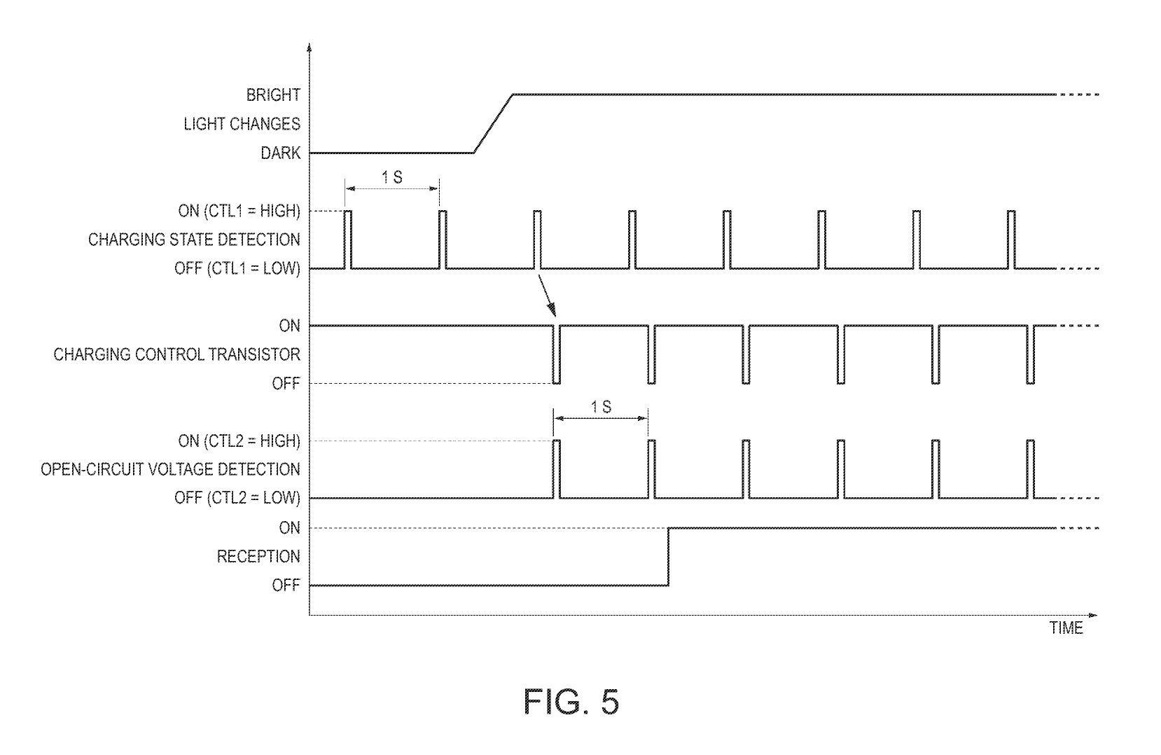

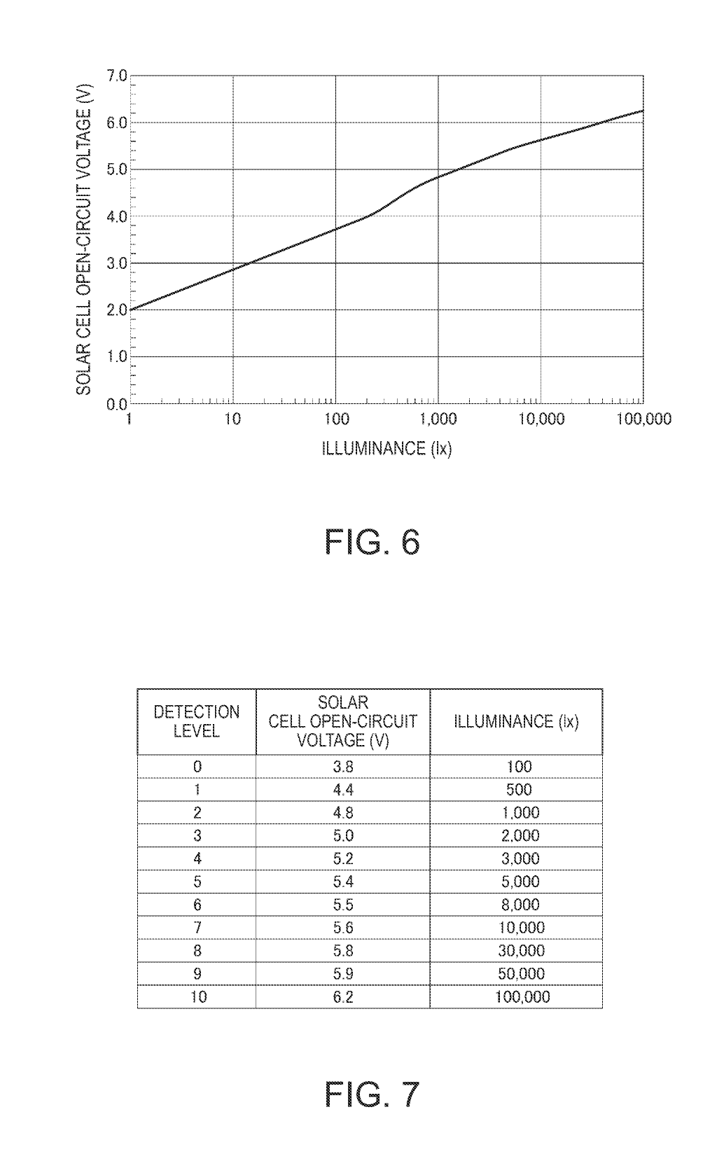

FIG. 4 is a flow chart of the satellite signal reception process of the control device 40 in the first embodiment of the invention. FIG. 5 describes the timing of generating state detection, open-circuit voltage detection, and the reception process. FIG. 6 is a graph showing the relationship between the illuminance of light incident to the solar cell 22 of the electronic timepiece 1 and the open-circuit voltage of the solar cell 22. FIG. 7 shows the relationship between the open-circuit voltage of the solar cell 22 and the illuminance of light incident to the solar cell 22 at various illuminance detection levels.

The operation of the control device 40 of the electronic timepiece 1 is described with reference to the flow chart in FIG. 4.

The control device 40 starts reception control at the reception control start time stored in the memory device 60. In this embodiment the reception control start time is set to 12:00:00 (24-hour time) daily. Therefore, when the internal time kept by the timekeeping unit 50 reaches 12:00:00, the control device 40 starts the reception control process shown in FIG. 4.

When reception control starts, the control device 40 first initializes variables H and T to 0 (SA1).

Variable H is a variable that indicates if the outdoor reception process was executed by the outdoor reception control unit 420 within a predetermined period of time, which in this embodiment is the 24-hour period from the control start time of 12:00 one day to 11:59:59 immediately before the control start time the following day. This variable H is initialized to 0, remains 0 if this process does not run, and is updated to 1 if this process executes.

Variable T is a variable that indicates if the scheduled reception process was performed by the scheduled reception control unit 430 within the same period of time (24 hours from 12:00), is initialized to 0, remains 0 if the process is not executed, and updated to 1 if the process is executed.

For example, if the scheduled reception time is 15:00, variable T is 0 from 12:00 to 15:00, and variable T is updated to 1 when the scheduled reception process is executed at 15:00. Thereafter, variable T remains 1 from 15:00 to 24:00 and to 12:00 the next day, and variable T is reinitialized to 0 at 12:00 the next day.

The timing for initializing the control start time, that is variables H and T, is not limited to 12:00:00 (noon), and can be set to 0:00:00 (midnight) when the date changes, or to some other time, such as 5:00:00 in the morning, based on when the user wakes up and starts the day. In other words, the control start time can be set appropriately to the application. A configuration enabling the user to set the control start time is also conceivable.

The control start time may also be set to two or more different times in one day, or once every two or more days. The length of time from one control start time to the next control start time is thus not limited to 24 hours, and may be set to any desirable time, but is normally preferably set to a period of a half day or more, such as half a day (12 hours), one day (24 hours), or two days (48 hours).

Variables H and T are also set to 1 if the reception process executes regardless of whether or not reception was successful or failed. More specifically, the variables are set to 1 even if reception fails.

Outdoor Reception Process

When variable H is 0, that is, the outdoor reception process has not executed, the control device 40 operates the outdoor reception control unit 420 and runs the outdoor reception process.

More specifically, after initializing the variables, the control device 40 checks if variable T=0 (SA2). The control device 40 operates the outdoor reception control unit 420 and executes the outdoor reception process if variable T=1 (SA2 returns NO) and variable H=0 (SA3 returns YES), or if variable T=0 (SA2 returns YES), the current time is not the scheduled reception time (SA11 returns NO), and variable H=0 (SA13 returns YES).

Outdoor Detection Process

The outdoor reception control unit 420 of the control device 40 determines if the illuminance detection level of the open-circuit voltage corresponding to the illuminance of light incident to the solar cell 22 twice consecutively equals or exceeds a set threshold level (detection level) (SA4).

More specifically, as shown in FIG. 5, the outdoor reception control unit 420 outputs control signal CTL1 at a 1-second interval and operates the generating state detector 43 of the outdoor detector 45 at a regular period. When the control signal CTL1 is input, the generating state detector 43 outputs detection result RS1 indicating whether or not power is being generated to the outdoor reception control unit 420. The outdoor reception control unit 420 can therefore determine whether or not the solar cell 22 is generating power. The charging control switch 42 turns off only at the timing when the voltage detector 44 of the outdoor detector 45 is operated.

The power generating state is detected at a 1-second interval in this embodiment, but the invention is not so limited and this interval may be set to 0.5 second, 10 second, 1 minute, or other desirable interval.

If the light on the electronic timepiece 1 is dim and the solar cell 22 is not generating power, the generating state detector 43 outputs a “not-generating” detection result RS1 to the outdoor reception control unit 420. In this event, the outdoor reception control unit 420 determines that power is not being generated (not-generating state), the outdoor reception control unit 420 outputs a low control signal CTL2 to the voltage detector 44, and does not operate the voltage detector 44.

When a not-generating state is detected, the outdoor reception control unit 420 determines that the electronic timepiece 1 is not outdoors and is likely not in a location suitable to receiving GPS signals, and does not run the reception process.

However, if a power generating state is detected, the outdoor reception control unit 420 operates the voltage detector 44 of the outdoor detector 45. In this event, the charging control switch 42 is turned off by the outdoor reception control unit 420 as described above. More specifically, if the generating state detector 43 determines that power is being generated, the outdoor reception control unit 420 outputs the control signal CTL1 at a 1-second interval and operates the voltage detector 44. In this event, the charging control switch 42 is switched off by the control signal from the outdoor reception control unit 420, and the solar cell 22 and voltage detector 44 are isolated from the storage battery 24. As a result, the voltage detector 44 can detect the open-circuit voltage at the illuminance of light on the solar cell 22 without being affected by the charge voltage of the storage battery 24.

Note that when the charging control switch 42 is off, the charging state cannot be detected by the generating state detector 43. The outdoor reception control unit 420 therefore controls the output timing of the control signal CTL1 to the generating state detector 43, and the output timing of the control signal CTL2 to the voltage detector 44 and the control signal to the charging control switch 42, so that they do not coincide.

The open-circuit voltage detected by the voltage detector 44 in this embodiment increases as the illuminance on the solar cell 22 increases as shown in FIG. 6.

Note that the voltage detector 44 can alternatively be configured to detect the illuminance on the solar cell 22 by detecting the short-circuit current of the solar cell 22 instead of the open-circuit voltage of the solar cell 22.

The outdoor reception control unit 420 evaluates the illuminance detection level corresponding to the open-circuit voltage based on the detection result RS2 output from the voltage detector 44. The outdoor reception control unit 420 in this embodiment determines the illuminance detection level based on the relationship shown in FIG. 7.

Note that the open-circuit voltage and illuminance in FIG. 7 denote the lower limit of each illuminance detection level. For example, when the open-circuit voltage is 5.6 V<=5.8 V, the control device 40 determines the illuminance detection level is 7, and if 5.9 V<=6.2 V, determines the illuminance detection level is 9.

The relationship between the illuminance detection level and open-circuit voltage of the solar cell is preset based on the relationship shown in FIG. 7. More specifically, the threshold values for determining if the illuminance detection level of the illuminance of light on the solar cell 22 is a high illuminance level or a low illuminance level are set based on this figure. However, the relationship between the illuminance detection level and the open-circuit voltage of the solar cell is not limited to the relationship shown in FIG. 7, and can be set appropriately.

Furthermore, the illuminance of light on the solar cell 22 under fluorescent lighting is normally 500 to 1000 lux, while the illuminance of light on the solar cell 22 when exposed to sunlight on a cloudy day is normally approximately 5000 lux. The illuminance detection level of 5 corresponding to light at 5000 lux being incident to the solar cell 22 is set as the threshold.

The threshold value for the illuminance detection level may be set to level 5 or above. In addition, if the illuminance detection level remains below the threshold level continuously for a specific time or longer, the threshold level may be reset to one level lower to loosen the condition for operating the GPS receiver module 30. By thus resetting the threshold level, the illuminance detection level can more easily reach the threshold, and more opportunities for operating the GPS receiver module 30 can be created.

When the solar cell 22 deteriorates and power conversion efficiency drops, the open-circuit voltage of the solar cell 22 will drop when exposed to light of the same illuminance, and the illuminance detection level evaluated by the control device 40 will therefore drop. The control device 40 will not be able to appropriately determine if the electronic timepiece 1 is outdoors in this event if the threshold level is fixed, and problems will result.

However, by lowering the threshold level in this event as described above, an opportunity to operate the GPS receiver module 30 can be created when light of 5000 lux is incident even if the illuminance detection level is a lower value than the threshold level of 5, such as 4 or less.

The control device 40 then determines if the illuminance detection level acquired from the detection result RS2 of the voltage detector 44 is twice consecutively equal to or greater than a detection level preset as the threshold level based on the voltage detected at the 1-second interval (SA4).

If SA4 returns NO (illuminance is low), the outdoor reception control unit 420 determines that the electronic timepiece 1 is not outdoors, and there is a strong possibility the electronic timepiece 1 is not in a location suited to GPS signal reception.

More specifically, if the electronic timepiece 1 is outdoors during the day, light exceeding the threshold should be continuously incident to the solar cell 22 for more than one second. Therefore, when the open-circuit voltage is detected at a 1-second interval, and an open-circuit voltage exceeding the threshold is detected twice consecutively, that there is a strong possibility the electronic timepiece 1 is outdoors can be determined.

However, an open-circuit voltage not exceeding the threshold twice consecutively can occur when, for example, the person wearing the wristwatch (electronic timepiece 1) is indoors and the open-circuit voltage does not once reach the threshold, or sunlight momentarily strikes the solar cell 22 through a building window and the open-circuit voltage does not twice consecutively exceed the threshold. Receiving GPS satellite signals under these conditions with good sensitivity is difficult.

This embodiment of the invention therefore determines in SA4 if the illuminance detection level twice consecutively equals or exceeds the threshold.

Note that this decision is not limited to the illuminance detection level twice consecutively exceeding the threshold. For example, to determine with greater precision if the user is outdoors, the condition could be that the illuminance detection level equals or exceeds the threshold 3 or more times consecutively.

When SA4 returns NO, the control device 40 determines if the current time is 11:59:59 (SA5).

If SA5 returns NO, the control device 40 returns to SA2 and continues the process. If SA5 returns YES, the reception control process ends, and the control device 40 then waits until the resume control time at which the next process starts. In this example, the resume control time is 1 second later at 12:00:00.

If SA4 returns YES, conditions are appropriate to receiving GPS signals as described above, and the outdoor reception control unit 420 starts the automatic reception process.

The outdoor reception control unit 420 therefore first sets variable H to 1 (SA6).

Next, the outdoor reception control unit 420 operates the GPS receiver module 30 and starts GPS signal reception (SA7).

The reception process started in SA7 is executed in the outdoor reception process executed when SA4 returns YES, and in the scheduled reception process described below. The outdoor reception process (light-based automatic reception process) and the scheduled reception process are collectively referred to below as the automatic reception process.

In the automatic reception process in SA7, the reception process executes in the timekeeping mode. More specifically, in the positioning mode signals must be received from three or more GPS satellites in order to detect the position, and the reception process takes a longer time. The electronic timepiece 1 is therefore preferably located outdoors until signal reception ends, but the user may not be aware that signals are being received in the automatic reception process, and could move indoors while reception is in progress. This embodiment therefore limits reception in the positioning mode to when the user intentionally starts reception, that is, only when the manual reception mode is selected.

However, time information can be acquired by receiving signals from only one GPS satellite in the timekeeping mode, and the reception process can therefore be completed in a short time. The reception process can therefore be executed even when not initiated by the user, and the time keeping mode is suited to the automatic reception process.

Determining if Reception is Successful

After automatic reception starts in SA7, the control device 40 determines if GPS satellite signal reception was successful (SA8).

Note that the GPS receiver module 30 first looks for a GPS satellite, and detects a GPS satellite signal with the GPS receiver module 30. If a GPS satellite signal is detected, receiving the GPS satellite signal continues and time information is received. If time information can thus be received, the control device 40 determines the reception process was successful in receiving the GPS satellite signal. Otherwise, when the GPS receiver module 30 cannot detect a GPS satellite signal or cannot acquire the time information, the control device 40 determines that the reception process failed at receiving the GPS satellite signal.

Time Correction Process

If the control device 40 determines the reception process was successful at receiving the GPS satellite signal (SA8 returns YES), the time correction unit 460 acquires the time information from the received satellite signal and corrects the internal time kept by the timekeeping unit 50 based on the acquired time information (SA9).

The control device 40 then stores the start time of the current successful automatic reception process (automatic reception success time) as the scheduled reception time in the memory device 60 (SA10).

The automatic reception success time recorded to the scheduled reception time is not limited to the time that automatic reception started when reception was successful, and could be the time that automatic reception end or the time expressed by the time information acquired from the satellite signal.

A default scheduled reception time can also be preset at the factory, or manually set by the user operating the external operating unit 70.

When SA8 returns NO, and when the internal time is corrected and the scheduled reception time is recorded in SA9 and SA10, the control device 40 evaluates the stop control time in SA5 in the same way as when SA4 returns NO.

If SA8 returns NO (reception failed), the threshold level may be set one level higher. By setting the threshold level one level higher, it will be more difficult for the detection level to equal or exceed the threshold level in the outdoor reception process the next day (SA4). More specifically, if the reception process executes while indoors because the electronic timepiece 1 is exposed to extremely bright lighting, the detection level equals or exceeds the threshold level, and reception fails, the threshold level is increased one level at a time. By thus raising the threshold level one level at a time, the detection level will eventually be below the threshold when exposed to the indoor lighting, and will equal or exceed the threshold only when the electronic timepiece 1 is outdoors and exposed to sunlight. The threshold level can therefore be adaptively optimized to the environment of the person using the electronic timepiece 1.

By making the condition for operating the GPS receiver module 30 more stringent when the GPS receiver module 30 fails to receive a GPS satellite signal, the GPS receiver module 30 can be operated in an environment suited to receiving a GPS satellite signal.

Scheduled Reception Process

If SA2 returns YES (because variable T=0), the scheduled reception control unit 430 of the control device 40 determines if the current time is the scheduled reception time (SA11).

As described above, the scheduled reception time is the start time of the last successful reception process, and is stored in the memory device 60. The scheduled reception control unit 430 therefore determines if the internal time kept by the timekeeping unit 50 has reached the scheduled reception time stored in the memory device 60.

Note that if the scheduled reception time is not stored in the memory device 60 due to a system reset, for example, a default time may be used as the scheduled reception time in SA11, or SA11 may return NO by default.

If the internal time has reached the scheduled reception time (SA11 returns YES), the scheduled reception control unit 430 sets variable T to 1 (SA12). The scheduled reception control unit 430 then operates the GPS receiver module 30 and starts the automatic reception process (SA7).

As in the outdoor reception process described above, the control device 40 determines if reception was successful (SA8), and if successful executes the internal time correction process (SA9) and records the scheduled reception time (SA10).

Note that when reception succeeds in the scheduled reception process, the start time of automatic reception is the same as the scheduled reception time stored in the memory device 60. The same time will therefore be set as the scheduled reception time in SA10. Recording the scheduled reception time in SA10 therefore happens when reception is successful in the outdoor reception process.

If SA11 returns NO, the control device 40 determines if variable H=0 (SA13). If SA13 returns YES, that is, variable T=0 and the scheduled reception process has not executed, and variable H=0 and the outdoor reception process has also not executed, the outdoor reception control unit 420 executes the outdoor reception process (SA4 to SA10).

However, if SA13 returns NO, that is, variable H=1 and the outdoor reception process has executed, but variable T=0 and the scheduled reception process has not executed, the control device 40 returns to the decision in SA5.

If SA3 returns NO, that is, variable T=1 and the scheduled reception process has executed, and variable H=1 and the outdoor reception process has also executed, the outdoor reception process and the scheduled reception process have executed once each. The control device 40 therefore ends the reception control process and waits until the resume control time of 12:00:00 the next day.

More specifically, ending reception control in the first embodiment of the invention is conditional upon executing both the outdoor reception process and the scheduled reception process once each irrespective of whether reception was successful.

The scheduled reception process always executes between one control start time and the next control start time, but the outdoor reception process cannot execute unless SA4 returns YES. When an outdoor location cannot be detected in SA4, steps SA2 to SA5 repeat until SA5 returns YES.

Effects of the first embodiment of the invention are described next.

The control device 40 has two types of automatic reception control units as the automatic reception control unit 410, an outdoor reception control unit 420 and a scheduled reception control unit 430. The number of opportunities for executing an automatic reception process meeting conditions for automatic reception can therefore be increased, and the probability of successfully receiving a satellite signal during a preset period of time (the 24-hour period from one reception control start time to the next reception control start time) can be increased.

More specifically, because the electronic timepiece 1 has an outdoor reception control unit 420, the reception process can be started automatically if the user wearing the electronic timepiece 1 moves outdoors and the electronic timepiece 1 can be determined to be outdoors. If the reception process is executed outdoors, the probability of successfully receiving a satellite signal transmitted from a GPS satellite 100 can also be increased compared with executing the reception process indoors, and wasteful consumption of power due to failed reception can be prevented.

Furthermore, because the electronic timepiece 1 also has a scheduled reception control unit 430, the reception process can be executed at a scheduled time when reception by the outdoor reception control unit 420 alone is not possible for a long time. For example, the electronic timepiece 1 may be outdoors, but cannot be determined to be outdoors because the electronic timepiece 1 is covered by the user's sleeve. In this situation, the outdoor reception control unit 420 cannot start the reception process.

The scheduled reception control unit 430, however, receives the satellite signal at the previously set scheduled reception time. The electronic timepiece 1 can therefore reliably execute the reception process independently of the result of determining if the electronic timepiece 1 is outdoors.

Opportunities for automatically correcting the time displayed by the electronic timepiece 1 based on time information from the satellite signal can therefore be increased, the correct time can always be displayed, and convenience can be improved.

Power consumption can also be suppressed and an efficient reception process can be executed because the control device 40 executes the outdoor reception process with the outdoor reception control unit 420 and the scheduled reception process with the scheduled reception control unit 430 once each during the predetermined period of time from the start time of the reception control process to the start time of the next reception control process.

More specifically, power consumption increases greatly if the reception process executes every time the user goes outdoors in one day. This embodiment of the invention limits power consumption, however, by limiting the outdoor reception process of the outdoor reception control unit 420 to once a day. Power consumption can also be limited because the scheduled reception process is limited to once a day and the automatic reception process is therefore limited to at most twice a day.

In this embodiment the start time of reception control is set to 12:00, and the predetermined period of time is set to 24 hours (1 day) until 12:00 the next day, the next start time for reception control. The user can then adjust the timing when the outdoor reception process and the scheduled reception process execute by setting the scheduled reception time assuming a preset start time, and operation can be configured so that the reception process executes at an appropriate time based on the daily schedule of the individual user.

If the user works indoors during the day and rarely goes outside until leaving work in the evening, detecting that the electronic timepiece 1 is outdoors with the solar cell 22 may not be possible. By setting the scheduled reception time according to when the user leaves work (such as 19:00) increases the probability of successful reception soon after reception becomes possible.

If the user is frequently outdoors during the day while working, there is a strong possibility that the outdoor reception process can be executed directly after reception control starts. If the scheduled reception time is set to the time while commuting the next morning in this situation, the reception process can be executed and the time corrected again before going to work the next day.

By thus setting the scheduled reception time according to the start time of reception control stored in the memory device 60, the reception process can be executed at a time appropriate to the daily schedule of the user, the possibility of successful reception can be increased, the correct time can be displayed, and convenience can be improved.

If the illuminance detection level of the open-circuit voltage detected by the voltage detector 44 is determined to equal or exceed the threshold level twice consecutively, this embodiment of the invention determines the electronic timepiece 1 is located outdoors, and receives a satellite signal.

The accuracy of the outdoor determination can therefore be improved, the possibility of mistakenly detecting an outdoor location while actually indoors can be reduced, and wasteful reception processes can be reduced.

In addition, the satellite signal is received at the scheduled reception time even if the electronic timepiece 1 is covered by a sleeve and cannot be determined to be outdoors even though the electronic timepiece 1 is outdoors. The reception process can therefore be executed reliably once a day regardless of the result of determining if the electronic timepiece 1 is outdoors, and being unable to correct the time because the reception process is not executed for a long time can be prevented.

The control device 40 also sets the time of the last successful reception as the scheduled reception time.

The scheduled reception time can therefore be set according to the daily schedule of the user, and the probability of successful reception can be increased. More particularly, by setting the time automatic reception was last successful as the scheduled reception time, reception can be scheduled based on the user's recent schedule.

The outdoor detector 45 includes a generating state detector 43 that detects the illuminance of light on the solar cell 22, and a voltage detector 44.

Indoors and outdoors can therefore be appropriately differentiated during the day, and the probability of successful reception can be increased.

The voltage detector 44 is also not operated when not charging, that is, when the solar cell 22 is not exposed to light, and wasteful power consumption can therefore be prevented, because the control device 40 operates the voltage detector 44 only when the charging state is detected by the generating state detector 43.

Because the generating state detector 43 runs the charging state detection process at a 1-second interval, and the generating state detection process of the voltage detector 44 executes only when the generating state detector 43 determines the solar cell 22 is generating power (is charging), the operating time of the voltage detector 44, which is the time that the charging control switch 42 is off, can be minimized. Reducing the charging efficiency of the solar cell 22 can therefore be suppressed.

### Embodiment 2

A second embodiment of the invention is described next with reference to accompanying figures.

The construction of the electronic timepiece 1 according to this embodiment of the invention is the same as in the first embodiment, and further description thereof is omitted or simplified.

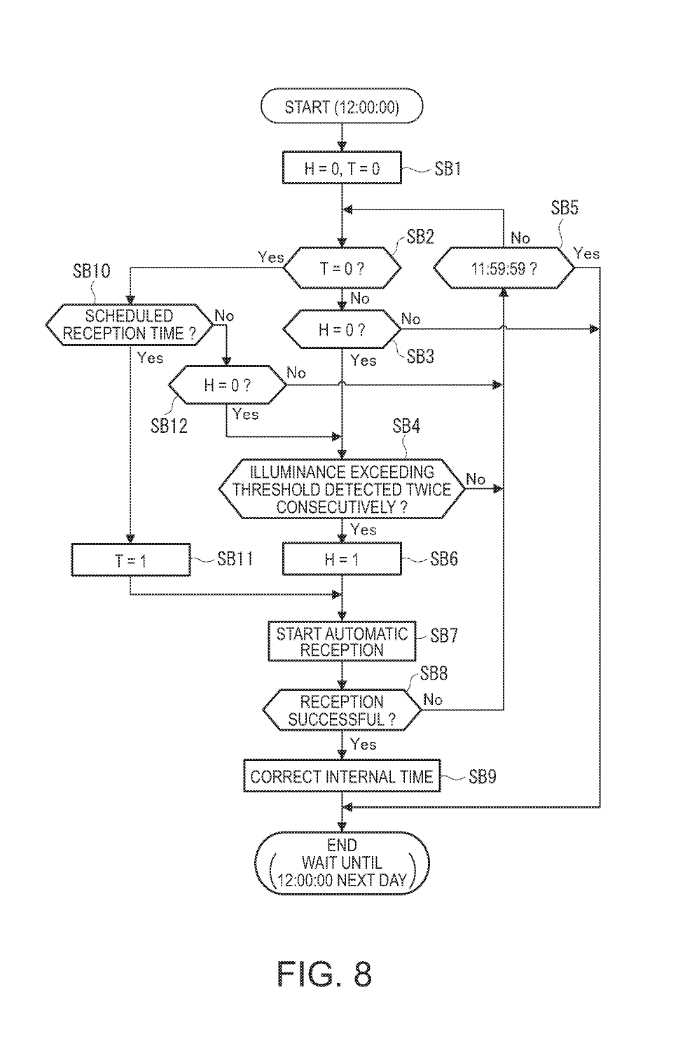

FIG. 8 is a flow chart of the satellite signal reception process of the control device 40 in this second embodiment of the invention.

As shown in FIG. 8, the control device 40 executes steps SB1 to SB11. Of these steps, SB1 to SB9 and SB10 to SB12 are the same as SA1 to SA9 and SA11 to SA13, respectively, in the first embodiment.

When successful reception is detected in SA8 in the first embodiment, the scheduled reception time is stored in SA10, control then returns to SA5, and the process continues.

When successful reception is detected in SB8 in this second embodiment, however, the control device 40 only corrects the internal time in SB9, and then ends the reception control process without configuring the scheduled reception process and without executing SB5, and waits until the control start time (12:00) the next day.

The second embodiment thus differs from the first embodiment as follows.

(i) When reception is successful in either the outdoor reception process or the scheduled reception process, operation waits until the control start time the next day without executing the other reception process. The condition for ending reception control is therefore that reception was successful in either the outdoor reception process or the scheduled reception process.

(ii) The scheduled reception time is not updated to the time of a successful automatic reception process.

The scheduled reception time in the second embodiment of the invention is set by the user and stored in the memory device 60. Methods whereby the user sets the scheduled reception time include the following.

(A) Setting the reception start time of a manual reception process started by operating the pusher 15 as the scheduled reception time if reception is successful

(B) Setting the reception end time of a manual reception process started by operating the pusher 15 as the scheduled reception time if reception is successful

(C) The user operating the crown 14, pushers 15, 16 or other external operating unit 70, and manually setting the scheduled reception time as desired

The manual setting method (C) can be achieved by, for example, moving the hands 12 to the scheduled reception time with the external operating unit 70, and pressing a specific button when the desired time is displayed to set the scheduled reception time to the time indicated by the hands 12.

In addition to the same effects achieved by the same processes in the first embodiment, this second embodiment of the invention also has the following effect.

Specifically, when reception is successful in the outdoor reception process or the scheduled reception process, the other automatic reception process is not executed. As a result, if reception is successful in either automatic reception process within the predetermined period of time, that is, 24 hours (1 day) after 12:00, reception is limited to once and power consumption can be further suppressed.

In addition, if an automatic reception process, either the outdoor reception process or the scheduled reception process, runs and reception fails (SB8 returns NO), the other automatic reception process is executed. In this event, the outdoor reception process and scheduled reception process are each executed once as in the first embodiment, and the probability of successful reception in receiving a satellite signal within the predetermined period of time can be improved.

For example, if reception fails in the scheduled reception process because the electronic timepiece 1 is indoors, the reception process can be executed when the outdoor reception process detects that the electronic timepiece 1 moved outdoors, and the probability of successful reception can be improved.

Furthermore, because the scheduled reception process can be executed when the outdoor reception process fails, the probability of successful reception can be increased. For example, if being outdoors is detected when the user leaves home in the morning and the automatic reception process starts, but the user then soon enters the garage because the user commutes by car, the satellite signals will be blocked by the roof and walls of the garage, and the outdoor reception process may fail. In this event, if the scheduled reception time is set to a time while driving the vehicle, the reception process can be executed while travelling outdoors by car, and the probability of successful satellite signal reception can be improved.

The average number of reception processes executed until reception is successful can therefore be reduced compared with the first embodiment, power consumption can be suppressed, and the duration time of the electronic timepiece 1 can be increased accordingly.

Because the scheduled reception time can be set manually by the user or by a manual reception process in the second embodiment, the user can set the scheduled reception time to a time suited to reception with consideration for the user's own schedule. The probability of successful reception during the scheduled reception process can therefore be improved.

### Embodiment 3

A third embodiment of the invention is described next with reference to accompanying figures.

The construction of the electronic timepiece 1 according to this embodiment of the invention is the same as in the first embodiment, and further description thereof is omitted or simplified.

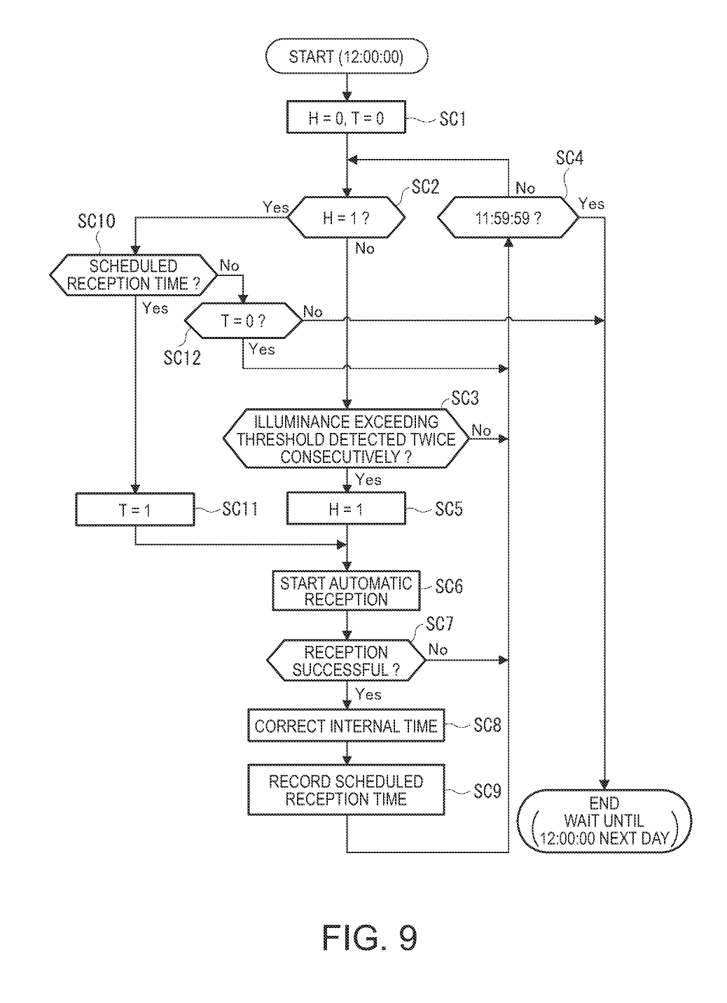

FIG. 9 is a flow chart of the satellite signal reception process of the control device 40 in this third embodiment of the invention.

This embodiment differs from the first embodiment as follows.

(i) The scheduled reception process is executed after the outdoor reception process is executed, and the sequence of the automatic reception processes is therefore defined.

Steps SC1 and SC3 to SC11 performed by the control device 40 are the same as steps SA1 and SA4 to SA12 in the first embodiment.

As shown in FIG. 9, the control device 40 determines if variable H=1 (SC12) after the variable initialization step (SC1). Because variable H=0 when the outdoor reception process has not executed, and H=1 when the process has executed, the control device 40 returns NO in SC2 until the outdoor reception process is executed.

When SC2 returns NO, the control device 40 operates the outdoor reception control unit 420 and runs the outdoor reception process (SC3 to SC9) as in the first embodiment. More specifically, the outdoor reception control unit 420 runs the automatic reception process (SC6) if the outdoor detector 45 detects an outdoor location, and if reception is successful, corrects the time (SC8) and records the scheduled reception time (SC9).

When the outdoor reception process is executed, variable H is set to 1 (SC5), and control returns to SC2, SC2 returns YES. The outdoor reception control unit 420 therefore does not execute a reception process a second time, and the scheduled reception control unit 430 runs the scheduled reception process.

More specifically, if the current time is the scheduled reception time in SC10 (SC10 returns YES), variable T is set to 1 in SC11 as in the first embodiment, and the automatic reception process is executed (SC6 to SC9).

However, if the current time is not the scheduled reception time, whether variable T=0 is determined in SC12. If the scheduled reception process has not executed and T=0, control goes to step SC4 and the process repeats until the scheduled reception time.

If the scheduled reception process executed and T=1, reception control ends and operation waits until the control start time the next day.

Because the scheduled reception process is not executed until the outdoor reception process is executed, the scheduled reception time may have passed when the outdoor reception process is executed. In this event, the outdoor reception process is executed without executing the scheduled reception process.

More specifically, the condition for ending the automatic reception process in the third embodiment is that the scheduled reception process was executed after the outdoor reception process was executed (SC12 returns NO), and if this condition is not satisfied, the automatic reception process continues until SC4 returns YES.

In addition to the same effects achieved by the same processes in the first embodiment, this third embodiment of the invention also has the following effect.

The probability of executing a wasteful reception process can be reduced because the control device 40 executes the scheduled reception process after the outdoor reception process has been executed. For example, if the automatic reception process runs on a holiday while the electronic timepiece 1 is left in a dresser drawer or other location where satellite signals cannot be received, power will be wastefully consumed.

However, the outdoor reception process is not executed if the electronic timepiece 1 is not exposed to light, and the scheduled reception process is also not executed in this event. Because neither the outdoor or scheduled automatic reception processes are executed when the electronic timepiece 1 is located where there is no light, such as in a drawer, the probability that the reception process will run in an environment where satellite signals cannot be received can be reduced, and power consumption can be reduced accordingly.

### Embodiment 4

A fourth embodiment of the invention is described next with reference to accompanying figures.

The construction of the electronic timepiece 1 according to this embodiment of the invention is the same as in the first embodiment, and further description thereof is omitted or simplified.

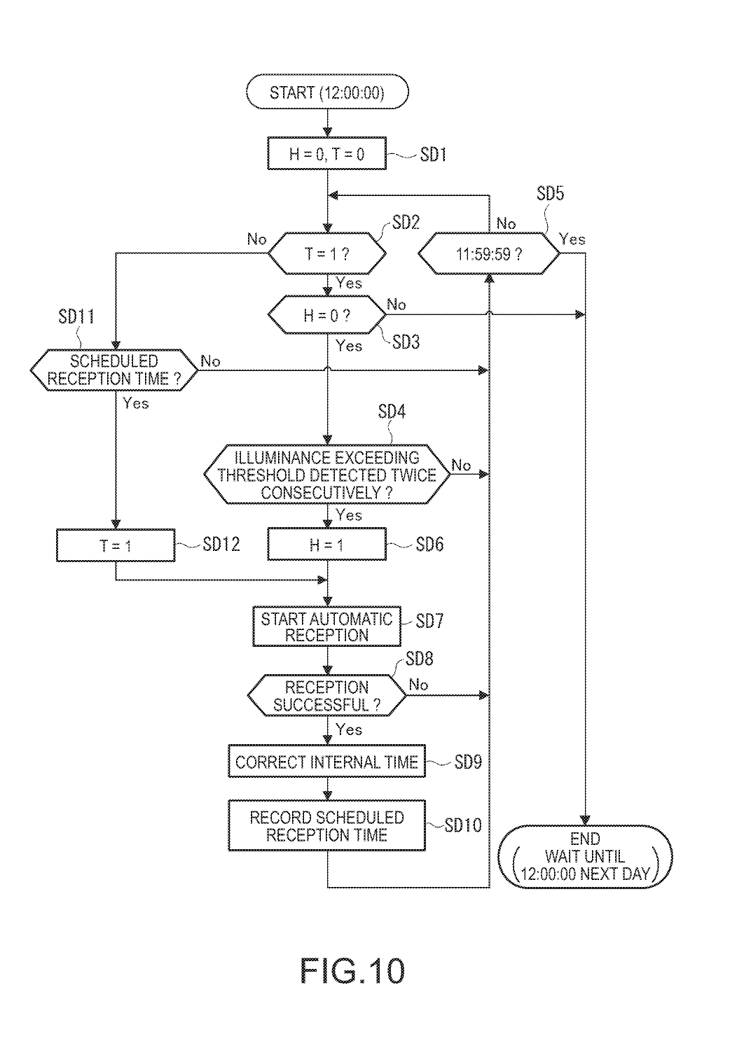

FIG. 10 is a flow chart of the satellite signal reception process of the control device 40 in this fourth embodiment of the invention.

This embodiment differs from the first embodiment as follows.

(i) The outdoor reception process executes after the scheduled reception process has been executed, and the order of the automatic reception processes is thus defined.

Steps SD1 and SD4 to SD12 performed by the control device 40 are the same as steps SA1 and SA4 to SA12 in the first embodiment.

As shown in FIG. 10, after variable initialization (SD1), the control device 40 determines if variable T=1 (SD2). Because variable T=0 if the scheduled reception process has not executed, and variable T=1 if the process has executed, the control device 40 returns NO in SD2 until the scheduled reception process has been executed.

If SD2 returns NO, the control device 40 operates the scheduled reception control unit 430 and runs the scheduled reception process (SD11, SD12, SD7-SD10, SD5) in the same way as the first embodiment. More specifically, if the current time has reached the scheduled reception time, the scheduled reception control unit 430 runs the automatic reception process (SD7), and if reception is successful, corrects the time (SD9) and records the scheduled reception time (SD10).

Once the scheduled reception process executes, variable T is set to 1 (SD12), and control returns to SD2, SD2 returns YES. As a result, the reception process is executed only once by the scheduled reception control unit 430.

If the outdoor reception process has not been run by the outdoor reception control unit 420 and SD3 returns NO, the outdoor reception process (SD4-SD10) is executed by the outdoor reception control unit 420 in the same way as the first embodiment.

Because variable H=1 after the outdoor reception process executes and SD3 returns NO, control ends and operation waits until the control start time the next day.

Because the outdoor reception process is not executed until the scheduled reception process has run, executing the outdoor reception process may not be possible when the scheduled reception process has executed depending upon the scheduled reception time and the control start time settings. For example, if the control start time is set to 00:00 midnight when the date changes, and the scheduled reception time is set to 21:00, SD4 may not be able to return YES from when the scheduled reception process executes (21:00) to the control end time (23:59:59) because it is night.

In this event, only the scheduled reception process executes and the outdoor reception process does not execute.

More specifically, the condition for ending the automatic reception process in this fourth embodiment is that the outdoor reception process has executed after the scheduled reception process executes (SD3 returns NO), and if this condition is not satisfied, the automatic reception process continues until YES is returned in SD5.

In addition to the same effects achieved by the same processes in the first embodiment, this fourth embodiment of the invention also has the following effect.

Because the control device 40 runs the outdoor reception process after the scheduled reception process has run, the reception process can be reliably once a day even when outdoors is not detected.

If the user knows the scheduled reception time, there is no need to be overly concerned about the outdoor reception process because the outdoor reception process does not execute until the time is reached. For example, the outdoor reception process starts when the illuminance level of light on the solar cell 22 equals or exceeds the threshold level for 2 seconds. The outdoor reception process may therefore start in the morning between when the user leaves the house and enters the garage for the daily commute, for example, but reception may fail in this situation because the user is in the garage. The automatic reception process may therefore execute needlessly each morning in this situation, but if the reception time is set so that the outdoor reception process does not execute until the scheduled reception process has executed as in this embodiment, wastefully executing the outdoor reception process can be prevented by setting the scheduled reception time appropriately.

The automatic reception process can therefore be executed effectively, and wasteful power consumption can be suppressed.

### Embodiment 5

A fifth embodiment of the invention is described next with reference to accompanying figures.

The construction of the electronic timepiece 1 according to this embodiment of the invention is the same as in the first embodiment, and further description thereof is omitted or simplified.

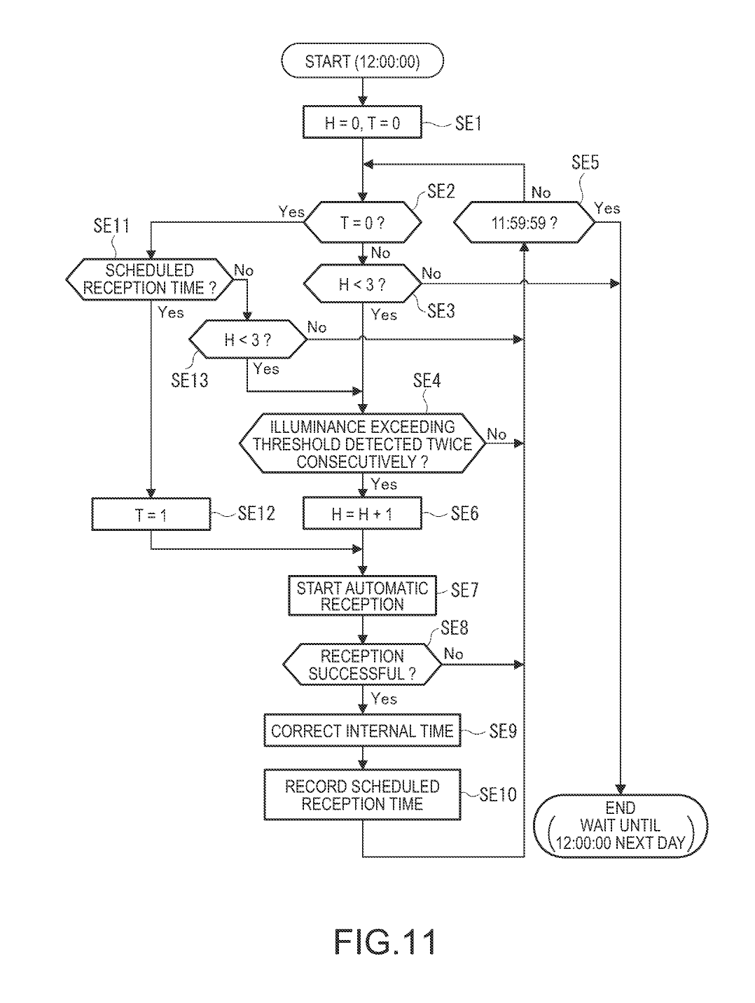

FIG. 11 is a flow chart of the satellite signal reception process of the control device 40 in this fifth embodiment of the invention.

As shown in FIG. 11, the control device 40 executes steps SE1 to SE13. Except for SE3, SE6, and SE13, the process of SE1 to SE13 is the same as steps SA1 to SA13 in the first embodiment.

In this fifth embodiment, 1 is added to variable H in SE6, and SE3 and SE13 determines if H<3. More specifically, variable H is initialized to 0, and H is incremented 1 each time outdoors is detected in SE4 and the outdoor reception process executes. Variable H thus indicates the number of times the outdoor receptionprocess is executed.

If H<3, that is, if H=0, 1, or 2, in SE3 or SE13, YES is returned and the outdoor reception process executes in SE4. However if H>=3, that is, the outdoor reception process has executed three times, NO is returned and SE4 does not execute.

This embodiment differs from the first embodiment as follows.

(i) The outdoor reception process executes three times and the scheduled reception process executes once.

This embodiment is otherwise the same as the first embodiment.

Note that if the user can manually set the threshold (3 in FIG. 11) that is used for comparison in SE3 and SE13, the user can set the number of times the outdoor reception process executes.

In addition to the same effects achieved by the same processes in the first embodiment, this fifth embodiment of the invention also has the following effect.

Because the number of times the outdoor reception process executes is increased to 3, the probability of successful reception in the specified period of time (1 day (24 hours) in this embodiment) can be improved. The probability that the time information can be acquired can therefore also be improved, and the correct time can be set and displayed.

### Embodiment 6

A sixth embodiment of the invention is described next with reference to accompanying figures.

The construction of the electronic timepiece 1 according to this embodiment of the invention is the same as in the first embodiment, and further description thereof is omitted or simplified.

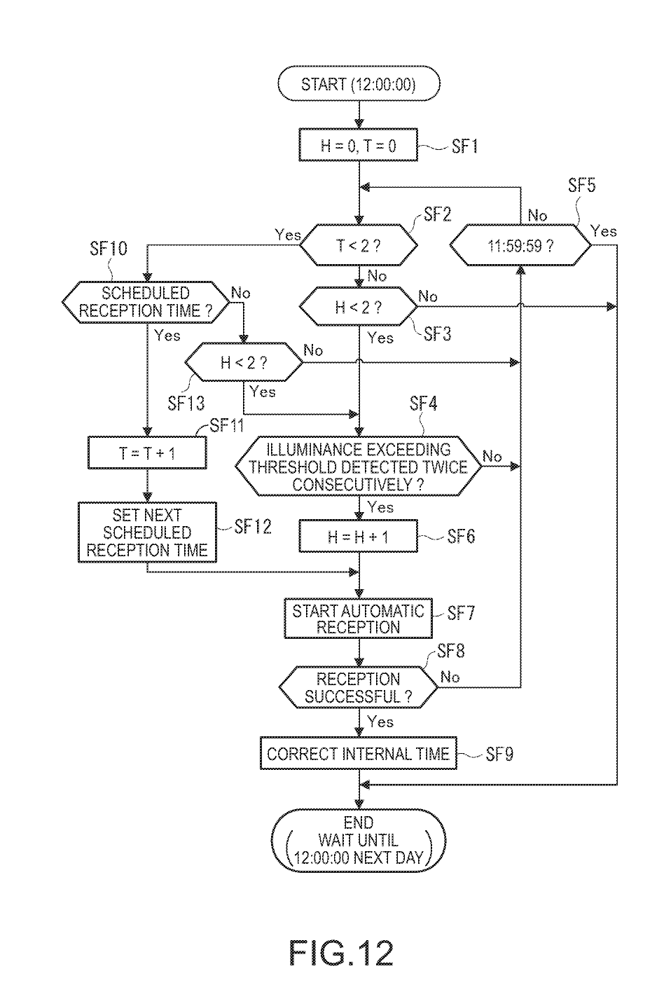

FIG. 12 is a flow chart of the satellite signal reception process of the control device 40 in this sixth embodiment of the invention.

As shown in FIG. 12, the control device 40 executes steps SF1 to SF13. Except for SF2, SF3, SF6, SF11, SF12, and SF13, the process of SF1 to SF13 is the same as steps SB1 to SB12 in the second embodiment.

In this sixth embodiment, 1 is added to variable H in SF6, and 1 is added to variable T in SF11. If T<2 is then determined in SF2, and SF3 and SF13 determine if H<2. More specifically, variables H and T are initialized to 0, H is incremented 1 each time the outdoor reception process executes, and T is incremented 1 each time the scheduled reception process executes. Variable H thus indicates the number of times the outdoor reception process is executed, and T indicates the number of times the scheduled reception process is executed.

If H<2, that is, if H=0 or 1, in SF3 or SF13, YES is returned and the outdoor reception process executes in SF4. However if H>=2, that is, the outdoor reception process has executed twice, NO is returned and SF4 does not execute.

If T<2, that is, if T=0 or 1, in SF2, YES is returned and the scheduled reception process executes in SF10. However if T=2, that is, the scheduled reception process has executed twice, NO is returned and SF10 is skipped.

Two scheduled reception times are recorded in the memory device 60 in this sixth embodiment, and when the scheduled reception time is reached in SF10, the next scheduled reception time is set in SF12. For example, if 19:00 and 7:00 are set in the memory device 60 as the scheduled reception times, the scheduled reception time is set to 19:00 at the start of reception control, the internal time kept by the timekeeping unit 50 goes to 19:00, and YES is returned in SF10, the scheduled reception time is then set to 7:00 in SF12. Likewise, when the internal time goes to 7:00 and YES is returned in SF10, the scheduled reception time is set to 19:00 in SF12.

As a result, unless reception fails, the second scheduled reception process executes when the internal time reaches the next set scheduled reception time.

This sixth embodiment differs from the second embodiment as follows.

(i) When reception does not succeed, the outdoor reception process executes twice and the scheduled reception process executes twice.

This embodiment is otherwise the same as the second embodiment.

Note that if the user can manually set the threshold (2 in FIG. 12) that is compared with H in SF3 and SF13, and input the threshold value compared with T in SF2 and the scheduled reception time, the user can individually set the number of times the outdoor reception process and the scheduled reception process execute.

In addition to the same effects achieved by the same processes in the second embodiment, this sixth embodiment of the invention also has the following effect.

Because the outdoor reception process is executed up to two times and the scheduled reception process is executed up to two times until successful reception is detected in SF8, the number of times the reception process executes when reception fails can be increased. As a result, the probability that reception will succeed and time information can be acquired can be improved, and the correct time can be set and displayed.

### Other Embodiments

The invention is not limited to the foregoing embodiments, and can be changed in many ways without departing from the scope of the accompanying claims.

For example, the outdoor detector 45 is not limited to using a solar cell 22, and a UV sensor or other type of sensor that can detect being outdoors may be used instead.

An embodiment that detects the voltage of the storage battery 24 and modifies the reception process according to the battery voltage is also conceivable. For example, an embodiment that executes the reception process described in embodiment 1 if the voltage equals or exceeds a preset threshold value, and executes the reception process of the second embodiment if the voltage is less than the threshold value, is conceivable. More specifically, the first embodiment executes the reception process twice a day even when reception succeeds, but the second embodiment executes the reception process only once if reception is successful and thereby reduces power consumption. Therefore, when the storage battery 24 voltage is high, the reception process of the first embodiment executes to give priority to increasing the number of times signals are received, but if the storage battery 24 voltage is low, the reception process of the second embodiment executes to reduce the number of times the reception process executes and save power.

An embodiment that executes the reception process of the fifth or sixth embodiment when the storage battery 24 voltage is high and equals or exceeds a threshold level, and executes the reception process of the first or second embodiment when the storage battery 24 voltage is below the threshold level and low, is also conceivable.

An embodiment that evaluates the voltage of the storage battery 24 in three levels, low, medium, and high, executes the reception process of the fifth or sixth embodiment when the voltage is high, executes the reception process of the first embodiment when the voltage is medium, and executes the reception process of the second embodiment when the voltage is low, is also conceivable.

The foregoing embodiments store the reception start time in the memory device 60 when reception is successful, but could also store the reception start time to the memory device 60 when reception fails. If the time reception fails is stored, the probability of successful reception can be improved by controlling the reception process to avoid times when reception failed in the past when the automatic reception process is executed.

The second embodiment ends reception control without running the other reception process when satellite signals are successfully received in either reception process, the outdoor reception process or the scheduled reception process. However, reception control could be ended without performing the other reception process when reception fails in either reception process. More specifically, when either the outdoor reception process or the scheduled reception process is executed, reception control can be ended without executing the other reception process whether the reception result is success or failure.

The third embodiment described above could be configured to run the scheduled reception process only if the outdoor reception process fails, and end reception control without executing the scheduled reception process if reception is successful in the outdoor reception process.

The fourth embodiment described above could be configured to run the outdoor reception process only if the scheduled reception process fails, and end reception control without executing the outdoor reception process if reception is successful in the scheduled reception process.

The foregoing embodiments are described with reference to a GPS satellite as an example of a positioning information satellite, but the positioning information satellite of the invention is not limited to GPS satellites and the invention can be used with Global Navigation Satellite Systems (GNSS) such as Galileo (EU), GLONASS (Russia), and Beidou (China), and other positioning information satellites that transmit satellite signals containing time information, including the SBAS and other geostationary or quasi-zenith satellites.

An electronic timepiece according to the invention is not limited to a wristwatch, and the invention can be used in a wide range of devices, including cell phones, mobile GPS receivers used in applications such as mountain climbing, and other battery-powered devices having a timekeeping function that receives satellite signals transmitted from positioning information satellites.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosure of Japanese Patent Application No: 2012-210460, filed Sep. 25, 2012 is expressly incorporated by reference herein.

What is claimed is:

1. An electronic timepiece comprising:
a receiver device that receives a satellite signal transmitted from a positioning information satellite;
an outdoor detection device that detects being outdoors;
a timekeeping device that keeps time;
a storage device that stores at least a reception control start time and a scheduled reception time; and
a control device that controls the receiver device and includes a reception control unit that starts reception control when the time kept by the timekeeping device reaches the reception control start time stored in the storage device, and when a preset stop reception control condition is met, stops reception control until the next reception control start time, and
a time correction unit that acquires time information contained in the satellite signal and corrects the time kept by the timekeeping device based on the acquired time information when satellite signal reception is successful;
the reception control unit including an outdoor reception control unit that operates the receiver device and executes an outdoor reception process when the outdoor detection device detects being outdoors, and
a scheduled reception control unit that operates the receiver device and executes a scheduled reception process when the time kept by the timekeeping device goes to the scheduled reception time.

2. The electronic timepiece described in claim 1, wherein:
the reception control unit ends reception control without executing the other reception process if satellite signal reception is successful in either the outdoor reception process or the scheduled reception process during the time from the start time stored in the storage device until the next start time,
but executes the other reception process if satellite signal reception fails in either the outdoor reception process or the scheduled reception process during this time.

3. The electronic timepiece described in claim 1, wherein:
the stop reception control condition is that the reception control unit executed the outdoor reception process once, and executed the scheduled reception process once, during the time from the start time stored in the storage device until the next start time.

4. The electronic timepiece described in claim 1, wherein:
the stop reception control condition is that the reception control unit executed the outdoor reception process a preset number of times, and executed the scheduled reception process number of times, during the time from the start time stored in the storage device until the next start time.

5. The electronic timepiece described in claim 1, further comprising:
an operating unit to manually input a time;
wherein the control device stores the time input by the operating unit as the scheduled reception time in the storage device.

6. The electronic timepiece described in claim 1, further comprising:
an operating unit to manually operate the receiver device;
wherein the control device has a manual reception control unit that operates the receiver device and executes a manual reception process when the reception operation of the operating unit is detected, and
stores the time reception succeeded as the scheduled reception time when satellite signal reception is successful in the manual reception process.

7. The electronic timepiece described in claim 1, wherein:
the control device stores the time reception succeeded as the scheduled reception time in the storage device when satellite signal reception is successful in the outdoor reception process.

8. The electronic timepiece described in claim 1, wherein:
the control device executes the scheduled reception process after executing the outdoor reception process during the time from the start time stored in the storage device until the next start time.

9. The electronic timepiece described in claim 1, wherein:
the control device executes the outdoor reception process after executing the scheduled reception process during the time from the start time stored in the storage device until the next start time.

10. The electronic timepiece described in claim 1, further comprising:
a solar cell;
wherein the outdoor detection device is an illuminance detection device that detects the illuminance of light incident to the solar cell; and
the control device determines the electronic timepiece is outdoors if the illuminance detected by the illuminance detection device equals or exceeds a preset threshold, and determines the electronic timepiece is not outdoors if less than the threshold.

11. The electronic timepiece described in claim 1, further comprising:
an operating unit to manually input a time;
wherein the control device stores the time input by the operating unit as the reception control start time in the storage device.

12. A control method of an electronic timepiece including a receiver device that receives a satellite signal transmitted from a positioning information satellite,
an outdoor detection device that detects being outdoors,
a timekeeping device that keeps time, and
a storage device that stores at least a reception control start time and a scheduled reception time,
the control method comprising steps of:
starting reception control when the time kept by the timekeeping device reaches the reception control start time stored in the storage device, and stopping reception control until the next reception control start time when a preset stop reception control condition is met,
reception control including executing an outdoor reception process that operates the receiver device when the outdoor detection device detects being outdoors, and
a scheduled reception process that operates the receiver device when the time kept by the timekeeping device goes to the scheduled reception time; and
acquiring time information contained in the satellite signal and correcting the time kept by the timekeeping device based on the acquired time information when satellite signal reception is successful.
